(19) United States
(12) Patent Application Publication
(10) Pub. No.: US 2024/0168206 A1
(43) Pub. Date: May 23, 2024

(54) SYSTEMS AND METHODS FOR POLYGON MIRROR ANGLES ADJUSTMENT

(71) Applicant: Innovusion, Inc., Sunnyvale, CA (US)

(72) Inventors: Ching-Ling Meng, Sunnyvale, CA (US); Ning-Yi Wang, Fremont, CA (US)

(73) Assignee: Innovusion, Inc., Sunnyvale, CA (US)

(21) Appl. No.: 18/511,982

(22) Filed: Nov. 16, 2023

Related U.S. Application Data
(60) Provisional application No. 63/426,352, filed on Nov. 17, 2022.

(51) Int. Cl. G02B 5/09; G01S 7/481; G02B 26/12

(52) U.S. Cl. CPC G02B 5/09; G01S 7/4817; G02B 26/12

(57) ABSTRACT

A light scanning device comprises a rotatable polygon-shaped structure comprising a frame, a plurality of mirror bonding plates configured to reflect light, and one or more flexures. At least some mirror bonding plates of the plurality of mirror bonding plates are adjustably attached to the frame based on corresponding flexures of the one or more flexures. A plurality of adjustment mechanisms is inserted between the frame and corresponding mirror bonding plates of the plurality of mirror bonding plates, where the plurality of adjustment mechanisms is configured to adjust tilt angles of the corresponding mirror bonding plates.

### CROSS-REFERENCE TO RELATED APPLICATIONS

This application claims priority to U.S. Provisional Patent Application Ser. No. 63/426,352, filed Nov. 17, 2022, entitled “SYSTEMS AND METHODS FOR POLYGON MIRROR ANGLES ADJUSTMENT,” the content of which is hereby incorporated by reference in its entirety for all purposes.

### FIELD OF THE TECHNOLOGY

This disclosure relates generally to an optical scanning device and, more particularly, to a rotatable polygon structure having mirror angle adjustment capabilities.

### BACKGROUND

Light detection and ranging (LiDAR) systems use light pulses to create an image or point cloud of the external environment. Some typical LiDAR systems include a light source, a light transmitter, a light steering system, and a light detector. The light source generates a light beam that is directed by the light steering system in particular directions when being transmitted from the LiDAR system. When a transmitted light beam is scattered by an object, a portion of the scattered light returns to the LiDAR system as a return light pulse. The light detector detects the return light pulse. Using the difference between the time that the return light pulse is detected and the time that a corresponding light pulse in the light beam is transmitted, the LiDAR system can determine the distance to the object using the speed of light. The light steering system can direct light beams along different paths to allow the LiDAR system to scan the surrounding environment and produce images or point clouds. LiDAR systems can also use techniques other than time-of-flight and scanning to measure the surrounding environment.

### SUMMARY

In certain LiDAR systems, a polygon mirror has a plurality of (e.g., four) reflective facets, each of which may have a different tilt angle. A tilt angle is the angle between the normal direction of the reflective facet and a rotational axis of the polygon mirror. Each facet can be used to generate a band of the vertical field-of-view scan pattern. The angle tolerances of each facet may need to be precisely controlled to be less than 0.01° so that the vertical gaps between each band are well controlled in the scan pattern. To achieve the tight tolerances, the cost may be high, or the tolerances may be even beyond general manufacturing capabilities. To solve the problem, an economical active alignment mechanism is desired. The present disclosure provides systems, devices, and method for solving the problem by using adjustment mechanisms together with flexures of the polygon-shaped structure to achieve desired facet tilt angles.

In one embodiment, a light scanning device comprises a rotatable polygon-shaped structure comprising a frame, a plurality of mirror bonding plates configured to reflect light, and one or more flexures. At least some mirror bonding plates of the plurality of mirror bonding plates are adjustably attached to the frame based on corresponding flexures of the one or more flexures. A plurality of adjustment mechanisms is inserted between the frame and corresponding mirror bonding plates of the plurality of mirror bonding plates, where the plurality of adjustment mechanisms is configured to adjust tilt angles of the corresponding mirror bonding plates.

In one embodiment, a method of fabricating a light scanning device comprises obtaining tilt angle requirements of a plurality of mirror bonding plates. A rotatable polygon-shaped structure comprising a frame, a plurality of mirror bonding plates, and one or more flexures is obtained, where tilt angles of the plurality of mirror bonding plates are configured to be less than the corresponding tilt angle requirements, and a plurality of adjustment mechanisms is inserted between the frame and corresponding mirror bonding plates of the plurality of mirror bonding plates to adjust the tilt angles according to the corresponding tilt angle requirements.

In some embodiments, the method may further comprise maintaining the required tilt angles using adjustment stopping mechanisms, and dispensing adhesives to hold the tilt angles in position.

In some embodiments, the tilt angle requirements of the plurality of mirror bonding plates may be different for different mirror bonding plates.

In some embodiments, the plurality of adjustment mechanisms may be inserted unidirectionally to increase gaps between the frame and corresponding mirror bonding plates of the plurality of mirror bonding plates.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more exemplary LiDAR systems disposed or included in a motor vehicle.

FIG. 2 is a block diagram illustrating interactions between an exemplary LiDAR system and multiple other systems including a vehicle perception and planning system.

FIG. 3 is a block diagram illustrating an exemplary LiDAR system.

FIG. 4 is a block diagram illustrating an exemplary fiber-based laser source.

FIGS. 5A-5C illustrate an exemplary LiDAR system using pulse signals to measure distances to objects disposed in a field-of-view (FOV).

FIG. 6 is a block diagram illustrating an exemplary apparatus used to implement systems, apparatus, and methods in various embodiments.

FIG. 7 is a perspective view of an example polygon-shaped structure of a light scanning device in accordance with various embodiments.

FIG. 8 is a cross-sectional view of an example polygon-shaped structure of a light scanning device in accordance with various embodiments.

FIG. 9 is a top-side view of an example polygon-shaped structure of a light scanning device in accordance with various embodiments.

FIG. 10 is a perspective view of an example top-side bracket mount for a polygon-shaped structure of a light scanning device in accordance with various embodiments.

FIG. 11 is a flow diagram of a method of fabricating a light scanning device in accordance with various embodiments.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

Although the following description uses terms “first,” “second,” etc. to describe various elements, these elements should not be limited by the terms. These terms are only used to distinguish one element from another. For example, a first mirror bonding plate could be termed a second mirror bonding plate and, similarly, a second mirror bonding plate could be termed a first mirror bonding plate, without departing from the scope of the various described examples. The first mirror bonding plate and the second mirror bonding plate can both be sensors and, in some cases, can be separate and different mirror bonding plate.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

Throughout the following disclosure, numerous references may be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, PLD. DSP, x86, ARM, RISC-V, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable medium storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, etc.). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

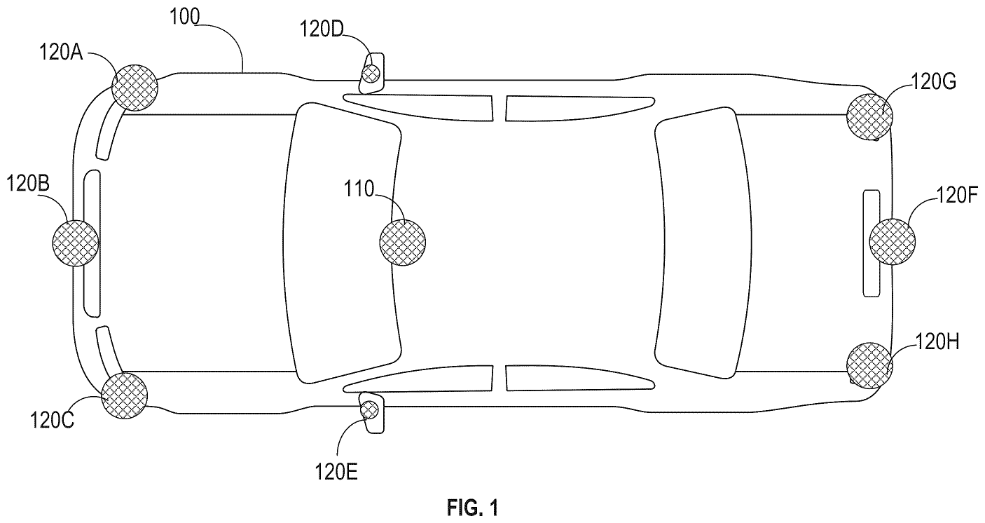

FIG. 1 illustrates one or more exemplary LiDAR systems 110 disposed or included in a motor vehicle 100. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-F. Each of LiDAR systems 110 and 120A-F can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is often an essential sensor of a vehicle that is at least partially automated. In one embodiment, as shown in FIG. 1, motor vehicle 100 may include a single LiDAR system 110 (e.g., without LiDAR systems 120A-F) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-F. As shown in FIG. 1, in one embodiment, multiple LiDAR systems 110 and/or 120A-F are attached to vehicle 100 at different locations of the vehicle. For example, LiDAR system 120A is attached to vehicle 100 at the front right corner; LiDAR system 120B is attached to vehicle 100 at the front center; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; and/or LiDAR system 120F is attached to vehicle 100 at the back center. In some embodiments, LiDAR systems 110 and 120A-F are independent LiDAR systems having their own respective laser sources, control electronics, transmitters, receivers, and/or steering mechanisms. In other embodiments, some of LiDAR systems 110 and 120A-F can share one or more components, thereby forming a distributed sensor system. In one example, optical fibers are used to deliver laser light from a centralized laser source to all LiDAR systems. It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

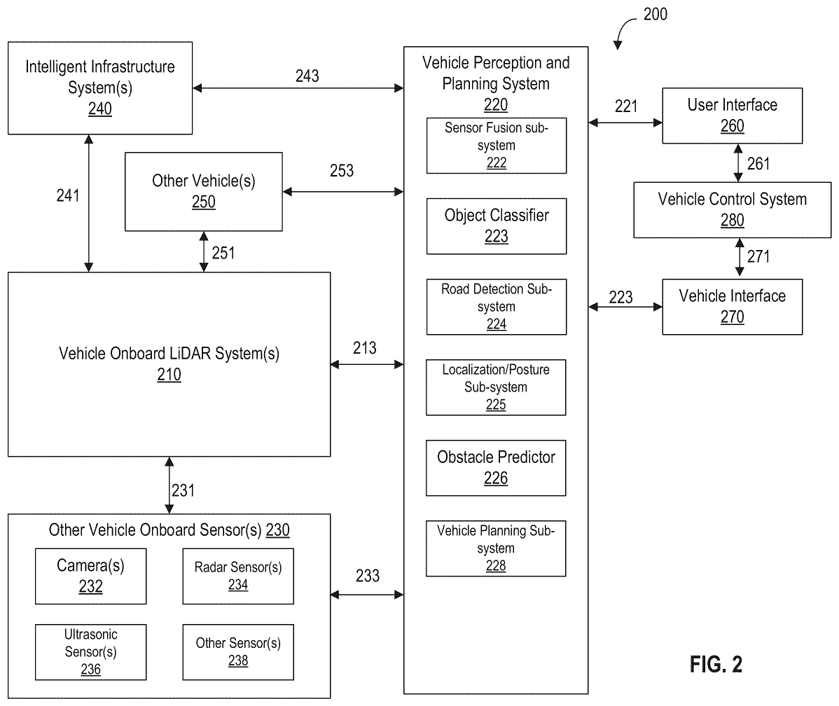

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-40 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 100-150 meters from the LiDAR sensor. Medium-range LiDAR sensors can be used for, e.g., monitoring road intersections, assistance for merging onto or leaving a freeway, or the like. A long-range LiDAR sensor measures objects located up to about 150-300 meters. Long-range LiDAR sensors are typically used when a vehicle is travelling at high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are used to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera produces monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data.

Other vehicle onboard sensor(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations.

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, check blind spot, identify parking spots, provide lane changing assistance into traffic, or the like. Sensor data generated by ultrasonic sensor(s) 236 can also be provided to vehicle perception and planning system 220 via communication path 233 for further processing and controlling the vehicle operations.

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud service for processing and then the processing results can be transmitted back to the vehicle perception and planning system 220).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is a behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210, thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffics in the opposite direction. In such a situation, sensors of intelligent infrastructure system(s) 240 can provide useful, and sometimes vital, data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle's steering mechanism, throttle, brake, etc., to operate the vehicle according to the planned route and movement. Vehicle perception and planning system 220 may further comprise a user interface 260, which provides a user (e.g., a driver) access to vehicle control system 280 to, for example, override or take over control of the vehicle when necessary. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

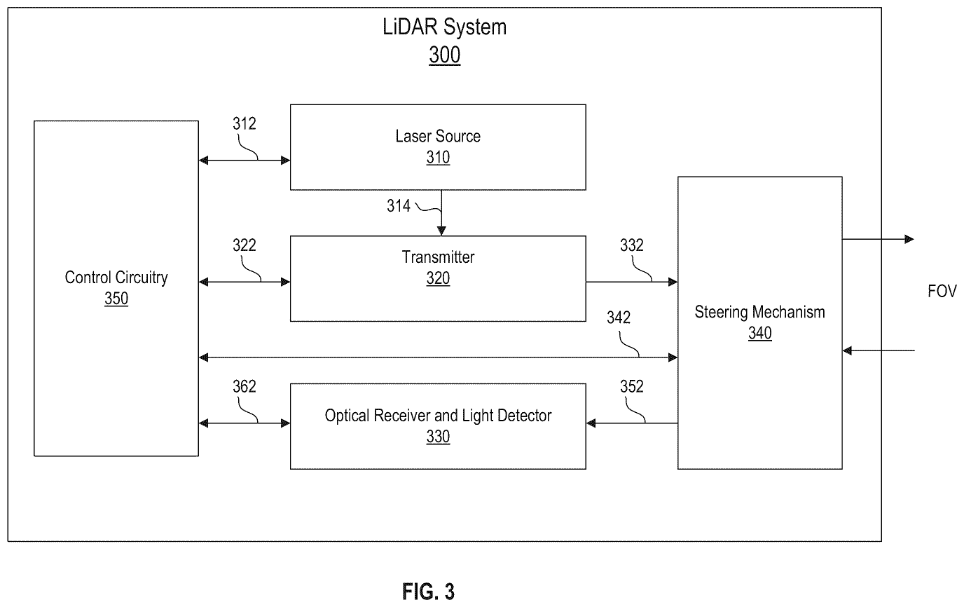

FIG. 3 is a block diagram illustrating an exemplary LiDAR system 300. LiDAR system 300 can be used to implement LiDAR system 110, 120A-F, and/or 210 shown in FIGS. 1 and 2. In one embodiment, LiDAR system 300 comprises a laser source 310, a transmitter 320, an optical receiver and light detector 330, a steering system 340, and a control circuitry 350. These components are coupled together using communications paths 312, 314, 322, 332, 343, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between laser source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Laser source 310 outputs laser light for illuminating objects in a field of view (FOV). Laser source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), or the like. A fiber-based laser is a laser in which the active gain medium is an optical fiber doped with rare-earth elements such as erbium, ytterbium, neodymium, dysprosium, prascodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high-power fiber laser source.

In some embodiments, laser source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, laser source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals.

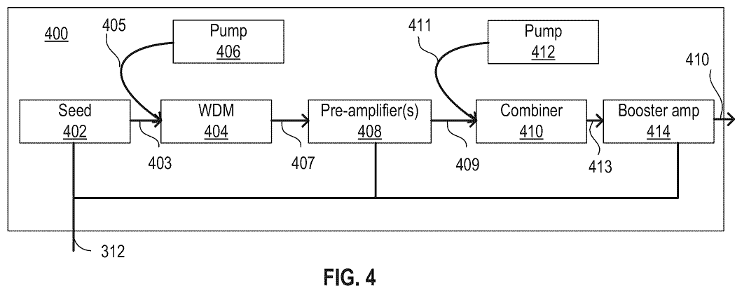

FIG. 4 is a block diagram illustrating an exemplary fiber-based laser source 400 having a seed laser and one or more pumps (e.g., laser diodes) for pumping desired output power. Fiber-based laser source 400 is an example of laser source 310 depicted in FIG. 3. In some embodiments, fiber-based laser source 400 comprises a seed laser 402 to generate initial light pulses of one or more wavelengths (e.g., 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 20-30 dB gain). In some embodiments, pre-amplifier(s) 408 are low noise amplifiers. Pre-amplifier(s) 408 output to a combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides pulses to a booster amplifier 414, which produces output light pulses via optical fiber 410. The booster amplifier 414 provides further amplification of the optical signals. The outputted light pulses can then be transmitted to transmitter 320 and/or steering mechanism 340 (shown in FIG. 3). It is understood that FIG. 4 illustrates one exemplary configuration of fiber-based laser source 400. Laser source 400 can have many other configurations using different combinations of one or more components shown in FIG. 4 and/or other components not shown in FIG. 4 (e.g., other components such as power supplies, lens, filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of laser source 310 comprise, for example, about 850 nm, about 905 nm, about 940 nm, about 1064 nm, and about 1550 nm. The upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from laser source 310 can be characterized by its peak power, average power, and the pulse energy. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. The PRR typically corresponds to the maximum range that a LiDAR system can measure. Laser source 310 can be configured to produce pulses at high PRR to meet the desired number of data points in a point cloud generated by the LiDAR system. Laser source 310 can also be configured to produce pulses at medium or low PRR to meet the desired maximum detection distance. Wall plug efficiency (WPE) is another factor to evaluate the total power consumption, which may be a key indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring laser source 310 and/or designing laser delivery systems for vehicle-mounted LiDAR applications.

It is understood that the above descriptions provide non-limiting examples of a laser source 310. Laser source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Laser source 310 provides laser light (e.g., in the form of a laser beam) to transmitter 320. The laser light provided by laser source 310 can be amplified laser light with a predetermined or controlled wavelength, pulse repetition rate, and/or power level. Transmitter 320 receives the laser light from laser source 310 and transmits the laser light to steering mechanism 340 with low divergence. In some embodiments, transmitter 320 can include, for example, optical components (e.g., lens, fibers, mirrors, etc.) for transmitting laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by laser source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, laser source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. Steering mechanism 340 will be described in more detail below. The laser light scanned to an FOV may be scattered or reflected by an object in the FOV. At least a portion of the scattered or reflected light returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focus, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One exemplary method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, a APD (avalanche photodiode) based structure, a PMT (photomultiplier tube) based structure, a SiPM (Silicon photomultiplier) based structure, a SPAD (single-photon avalanche diode) base structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise (TIA). In some embodiments, optical receiver and light detector 330 may include a pre-amplifier that is a low noise amplifier (LNA). In some embodiments, the pre-amplifier may also include a TIA-transimpedance amplifier, which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implement signal processing techniques (e.g., filtering, noise reduction, amplification, or the like). For example, in addition to or instead of using direct detection of return signals (e.g., by using TOF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism or a scanning mechanism. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an exemplary non-scanning LiDAR system).

Steering mechanism 340 can be used with the transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or two devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s) for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lens) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling laser source 310 to obtain desired laser pulse timing, repetition rate, and power; controlling steering mechanism 340 (e.g., controlling the speed, direction, and/or other parameters) to scan the FOV and maintain pixel registration/alignment; controlling optical receiver and light detector 330 (e.g., controlling the sensitivity, noise reduction, filtering, and/or other parameters) such that it is an optimal state; and monitoring overall system health/status for functional safety.

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; and/or determines any other type of data relevant to LiDAR system 300.

LiDAR system 300 can be disposed in a vehicle, which may operate in many different environments including hot or cold weather, rough road conditions that may cause intense vibration, high or low humidifies, dusty areas, etc. Therefore, in some embodiments, optical and/or electronic components of LiDAR system 300 (e.g., optics in transmitter 320, optical receiver and light detector 330, and steering mechanism 340) are disposed or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one exemplary LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

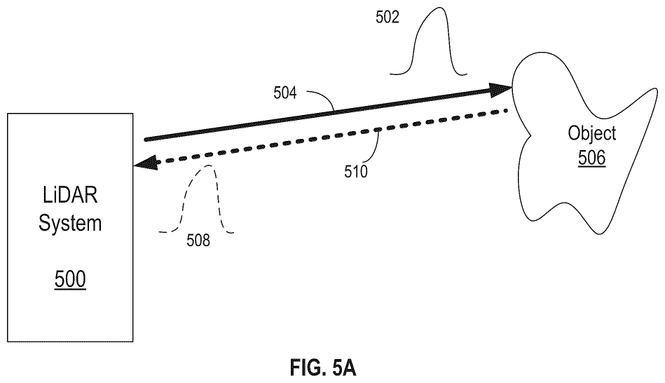

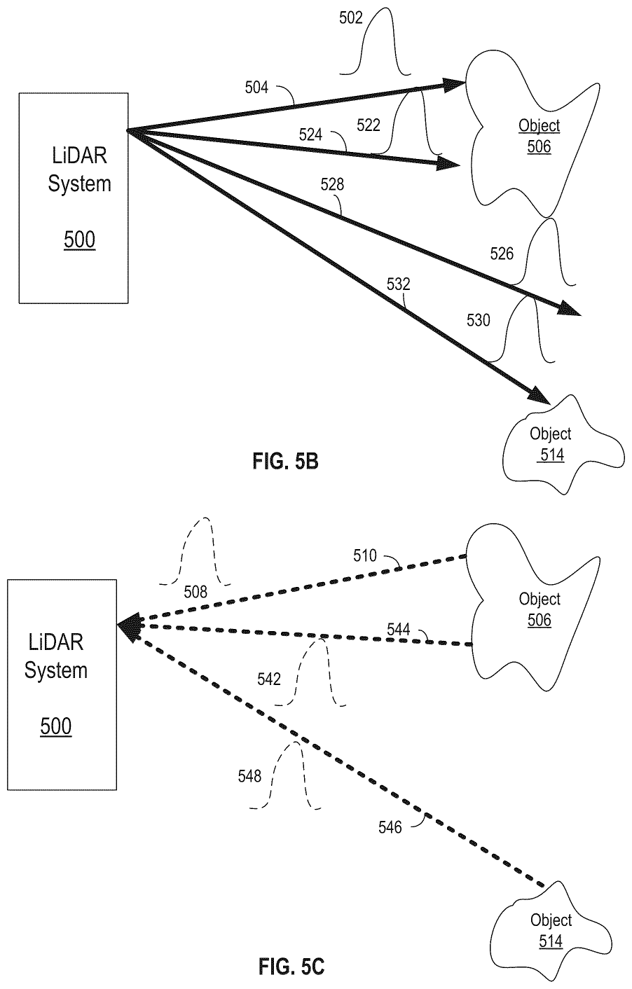

As described above, some LiDAR systems use the time-of-flight (TOF) of light signals (e.g., light pulses) to determine the distance to objects in a light path. For example, with reference to FIG. 5A, an exemplary LiDAR system 500 includes a laser light source (e.g., a fiber laser), a steering system (e.g., a system of one or more moving mirrors), and a light detector (e.g., a photon detector with one or more optics). LiDAR system 500 can be implemented using, for example, LiDAR system 300 described above. LiDAR system 500 transmits a light pulse 502 along light path 504 as determined by the steering system of LiDAR system 500. In the depicted example, light pulse 502, which is generated by the laser light source, is a short pulse of laser light. Further, the signal steering system of the LiDAR system 500 is a pulsed-signal steering system. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to generate a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are generated by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then it may be determined that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source with a higher pulse repetition rate (PRR) is needed. On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an exemplary LiDAR system that can transmit laser pulses with a repetition rate between 500 kHz and 1 MHZ. Based on the time it takes for a pulse to return to the LiDAR system and to avoid mix-up of return pulses from consecutive pulses in a conventional LiDAR design, the farthest distance the LiDAR system can detect may be 300 meters and 150 meters for 500 kHz and 1 MHZ, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHZ (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of some of FIGS. 1-10, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

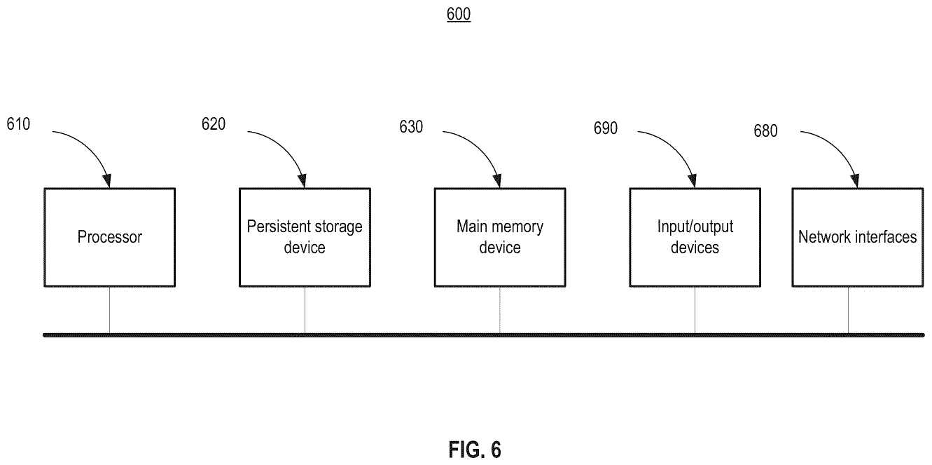

A high-level block diagram of an exemplary apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of some of FIGS. 1-5 and 7-11 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps of some of FIGS. 1-5 and 7-11. Accordingly, by executing the computer program instructions, the processor 610 executes an algorithm defined by the methods of some of FIGS. 1-5 and 7-11. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

The present disclosure provides systems, devices, and methods for polygon mirror angle adjustment. The polygon mirror facet active alignment mechanism disclosed herein uses flexure springs corresponding to polygon mirror reflective facets, each of which may have a different tilt angle. A tilt angle is the angle between the normal direction of the reflective facet and a rotational axis of the polygon mirror. Each facet can be used to generate a band of the vertical field-of-view scan pattern, e.g., in a light ranging and detection (LiDAR) system or device for light scanning comprising the polygon mirror active alignment mechanism described herein. Moreover, a vehicle may comprise a light ranging and detection (LiDAR) system or device for light scanning including polygon mirror active alignment mechanism described herein. For LiDAR applications, the angle tolerances of each polygon mirror facet may need to be precisely controlled to be less than 0.01° so that the vertical gaps between each band are well controlled in a scan pattern. To achieve the tight tolerances, the manufacturing cost may be high, or the tolerances may be even beyond general manufacturability. To solve the problem, an economical active alignment mechanism disclosed herein.

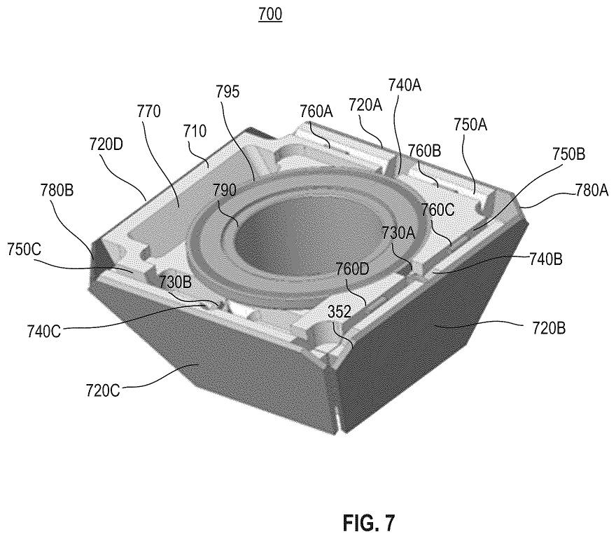

FIG. 7 is a perspective view of an example polygon-shaped structure 700 of a light scanning device in accordance with various embodiments. From a perspective view, the polygon-shaped structure 700 comprises a polygon frame 710, a plurality of wafer mirrors connected to or integrated with corresponding mirror bonding plates 720A-D, a plurality of adjustment mechanisms (e.g., tapered jack/drive screws) 730A-B disposed within respective holes 740A-C, one or more V-shaped grooves 750A-C configured to receive one or more adjustment-stopping mechanisms (e.g., dowel pins) 760A-D, one or more frame cutouts 770, one or more chamfered corners 780A-B, a magnet ring 790, and an encoder ring 795.

Polygon-shaped structure 700 comprises an active alignment mechanism for one or more polygon mirrors. In the active alignment mechanism, each mirror bonding plate 720A-D is connected to the polygon frame 710 by a flexure. For example, the mirror bonding plates 720A-D may be fabricated such that their tilt angles are 0.5° less than a nominal angle. In other words, the tilt angles between the normal direction of the reflective facets and a rotational axis of the polygon mirror can be fabricated to be 0.5° less than a desired nominal angle. This degree of leeway eliminates the requirement to precisely control the manufacturing of the facets to be within the strict angle tolerance requirements, e.g., within 0.01°, necessary for a well-controlled scan pattern. To achieve such tight tolerances, the manufacturing costs may be high, and the angle tolerances may even be beyond typical manufacturing capabilities. But when the active alignment mechanism described herein is implemented for post-fabrication tilt angle adjustment, an adjustment mechanism 730, e.g., a tapered jack/drive screw, can be used to increase a gap between the mirror bonding plate 720 and the polygon frame 710, and therefore increase the tilt angle of the mirror bonding plate 720 to a nominal value (e.g., a desired value). In the process, the flexure provides the returning force to maintain the adjusted gap implemented by the adjustment mechanism 730.

In FIG. 7, a rotatable polygon-shaped structure 700 of a light scanning device comprises a frame 710, a plurality of mirror bonding plates 720A-D configured to reflect light, and one or more flexures (not shown), where at least some of the mirror bonding plates of the plurality of mirror bonding plates 720A-D are adjustably attached to the frame 710 based on corresponding flexures. A plurality of adjustment mechanisms 730, e.g., adjustment mechanisms 730A-B, is inserted between the frame 710 and corresponding adjustable mirror bonding plates, e.g., mirror bonding plates 720A-C, where the plurality of adjustment mechanisms 730 is configured to adjust tilt angles of the corresponding adjustable mirror bonding plates 720A-C to desired tilt angles.

In some embodiments, a non-adjustable mirror bonding plate, e.g., mirror bonding plate 720D, of the plurality of mirror bonding plates 720A-D may be rigidly connected to, or form an integral part of, the frame 710 such that a tilt angle of the non-adjustable mirror bonding plate 720D is not adjustable, while tilt angles of other mirror bonding plates, e.g., mirror bonding plates 720A-C, may be adjustable. As shown in FIG. 7, the plurality of mirror bonding plates 720A-D comprises three adjustable mirror bonding plates 720A-C in addition to the non-adjustable mirror bonding plate 720D. Thus, the tilt angles of the adjustable mirror bonding plates 720A-C may be adjusted with respect to the fixed (i.e., reference) tilt angle of the non-adjustable mirror bonding plate 720D. For example, the tilt angles of the adjustable mirror bonding plates 720A-C may be configured to be adjusted by +/−‘X’ degrees relative to the tilt angle of the non-adjustable mirror bonding plate 720D.

In some embodiments, each mirror bonding plate of the plurality of mirror bonding plates 720A-D can have a tilt angle that is different from tilt angles of other mirror bonding plates. For example, a tilt angle of a first mirror bonding plate 720A may be different from desired tilt angles of one or more of mirror bonding plates 720B-D; a desired tilt angle of a second mirror bonding plate 720B may be different from desired tilt angles of one or more of mirror bonding plates 720A, C and D; a desired tilt angle of a third mirror bonding plate 720C may be different from desired tilt angles of one or more of mirror bonding plates 720A, B and D; or a desired tilt angle of a fourth mirror bonding plate 720D may be different from desired tilt angles of one or more of mirror bonding plates 720A-C.

In some embodiments, at least one of the plurality of adjustment mechanisms, e.g., adjustment mechanisms 730A-B, can be configured to adjust a tilt angle of a corresponding mirror bonding plate 720 by increasing a gap between the frame 710 and the corresponding mirror bonding plate 720. For example, a plurality of holes 740A-C may be disposed between the frame 710 and corresponding mirror bonding plates 720A-C, where at least one adjustment mechanism, e.g., each of adjustment mechanisms 730A-B is inserted at least partially into a corresponding hole, e.g., holes 740B-C, respectively. For example, the plurality of holes 740A-C may be threaded holes and the plurality of adjustment mechanisms 730A-B may comprise tapered jack/drive screws.

Polygon-shaped structure 700 further comprises a plurality of grooves 750A-C. For example, one or more adjustment-stopping mechanisms, e.g., adjustment-stopping mechanisms 760A-D, may be at least partially disposed in corresponding grooves, e.g., grooves 750A-B, where the one or more adjustment-stopping mechanisms 760A-D are configured to stop corresponding mirror bonding plates 720, e.g., mirror bonding plates 720A-B, from retracting such that the tilt angles of the corresponding mirror bonding plates 720 are maintained after adjustment. The one or more adjustment-stopping mechanisms 760A-D may comprise dowel pins, and the plurality of grooves 750A-C may be V-shaped grooves such that when an adjustment mechanism 730 is adjusted (e.g., a tapered jack/drive screw adjustment mechanism 730 is tightened to drive further into a threaded hole 740), an adjustment-stopping mechanism/dowel pin 760 disposed in a groove 750 corresponding to the adjustment mechanism 730 will fall deeper (i.e., downward in a direction along a z-axis) into the groove 750. For example, when tapered jack/drive screw adjustment mechanism 730A is tightened to drive further into threaded hole 740B, the adjustment-stopping mechanisms/dowel pins 760C-D disposed in groove 750B will fall deeper (i.e., in a direction along a z-axis) into groove 750B. In an embodiment, adhesives (not shown) may be dispensed to hold the adjustment-stopping mechanisms/dowel pins 760 (and the tilt angle of the corresponding mirror bonding plate 720) in position. For example, dispensing adhesives may include dispensing controlled deposits of one or more of the following: adhesives, glues, sealants, silicones, epoxy resins, solder paste, grease, flux, solvents, lubricants, and/or other materials. Such adhesives may be dispensed using. e.g., hand-held dispensers/applicators, robot dispensers/applicators, or combinations thereof.

In some embodiments, each of the plurality of mirror bonding plates 720A-D may comprise a reflective surface forming a side surface of the polygon-shaped structure 700. For example, the reflective surface may comprise a semiconductor wafer based reflective surface, or a mirror. The side surface of the polygon-shaped structure 700 may have a trapezoidal shape and one or more chamfered corners 780A-B, as shown. However, other side surface shapes and corner configurations are possible within the scope of the embodiments herein.

In some embodiments, the polygon-shaped structure 700 may be configured to scan light to a field-of-view (FOV) comprising a plurality of sub-FOVs, and each mirror bonding plate of the plurality of mirror bonding plates 720A-D may be configured to form a scan pattern by scanning light to a sub-FOV of the plurality of sub-FOVs. For example, the FOV may be a vertical FOV.

The degrees of insertion of the plurality of adjustment mechanisms 730A-B can be configured to be different such that the tilt angles of different mirror bonding plates 720 are different. For example, the tilt angles of the different mirror bonding plates 720 can be configured such that the scan patterns formed by using reflective facets of the different mirror bonding plates 720 correspond to different sub-FOVs of the FOV. In various embodiments, the scan patterns formed by using the reflective facets of the different mirror bonding plates of the plurality of mirror bonding plates 720 may be configured as desired. For example, the scan patterns formed by using the reflective facets of the different mirror bonding plates of the plurality of mirror bonding plates may be non-overlapping. Further, the scan patterns formed by using the reflective facets of two adjacent mirror bonding plates of the plurality of mirror bonding plates, e.g., mirror bonding plates 720B and 720C, may be continuous without skipped scanlines, and/or overlapping. In some embodiments, at least a part of the polygon-shaped structure 700 may comprise a material, e.g., titanium, that has a coefficient of thermal expansion (CTE) matching with a CTE of reflective facets of the mirror bonding plates 720. The polygon-shaped structure 700 may further comprise one or more cutouts 770 configured to reduce weight imbalance when rotating.

Polygon structure 700 further comprises a magnet ring 790 and an encoder ring 795. Magnetic ring 790 and rotary encoder ring 795 provide for rotary operation and feedback control, respectively, of a motor (not shown) used to rotate the polygon structure 700 about a base, e.g., a base of a LIDAR device housing.

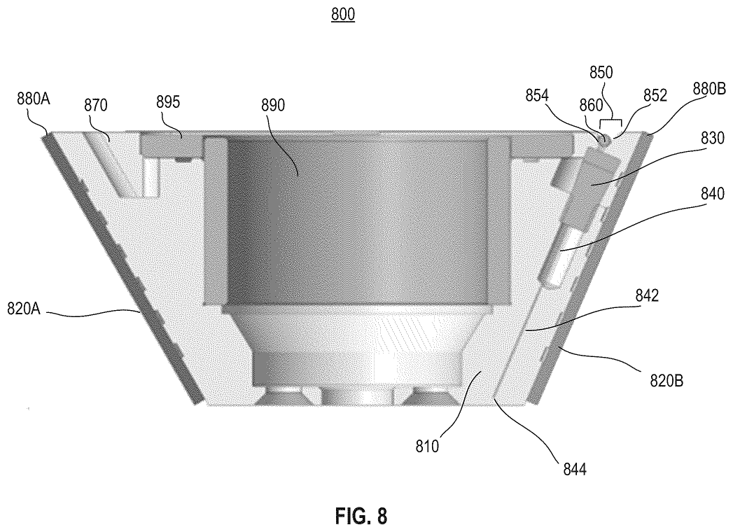

FIG. 8 is a cross-sectional view of an example polygon-shaped structure 800 of a light scanning device in accordance with various embodiments. In the cross-sectional view, polygon-shaped structure 800 comprises a polygon frame 810, a plurality of wafer mirrors connected to or integrated with corresponding mirror bonding plates 820A-B, an adjustment mechanism (e.g., a tapered jack/drive screw) 830 disposed within a hole 840, a gap/slot 842, a flexure 844, a V-shaped groove 850 configured to receive one or more adjustment-stopping mechanisms (e.g., one or more dowel pins) 860, one or more frame cutouts 870, one or more chamfered corners 880A-B, a magnet ring 890, and an encoder ring 895.

In FIG. 8, a mechanism for adjusting a tilt angle of a mirror bonding plate of a polygon-shaped structure 800 is shown in more detail. For example, rotatable polygon-shaped structure 800 comprises a frame 810 and a plurality of mirror bonding plates 820A-B configured to reflect light. Rotatable polygon-shaped structure 800 further comprises one or more flexures 844, where at least some of the mirror bonding plates are adjustably attached to the frame 810 based on a corresponding flexure 844. For example, mirror bonding plate 820B is adjustably attached to the frame 810 based on corresponding flexure 844.

In some embodiments, one or more adjustment mechanisms, e.g., adjustment mechanism 830 as shown, can be inserted between the frame 810 and a corresponding mirror bonding plate, e.g., mirror bonding plate 820B, where the adjustment mechanism(s) 830 are configured to adjust tilt angles of the corresponding mirror bonding plates 820 to desired tilt angles. For example, a desired tilt angle can be measured relative a fixed reference tilt angle (e.g., a tilt angle of mirror bonding plate 820A) or relative to a rotational axis of polygon-shaped structure 800. A plurality of holes 840 may be disposed between the frame 810 and a plurality of mirror bonding plates 820, where at least one adjustment mechanism 830 is inserted at least partially into at least one corresponding hole, e.g., hole 840, of the plurality of holes. For example, adjustment mechanism 830 may be a tapered jack/drive screw inserted into a threaded hole 840 between the frame 810 and corresponding mirror bonding plate 820B, where adjustment mechanism 830 is configured to adjust the tilt angle of mirror bonding plate 820B to a desired tilt angle.

In some embodiments, a plurality of adjustment mechanisms 830 may be configured to unidirectionally increase a gap 842 (also referred to herein as a slot) between the frame 810 and a corresponding mirror bonding plate 820. For example, adjustment mechanism 830 may be configured to unidirectionally increase the gap 842 between the frame 810 and corresponding mirror bonding plate 820B. In another example, one or more of the plurality of adjustment mechanisms 830 also may be configured to allow for bidirectional adjustment of a gap 842, where the tilt angle of a corresponding mirror bonding plate 820 can be increased or decreased as desired.

In some embodiments, one or more gaps 842 may be formed between the frame 810 and one or more corresponding mirror bonding plates 820 of the plurality of mirror bonding plates. For example, gap 842 may be a slot cut by wire electrical discharge machining (EDM) between the frame 810 and mirror bonding plate 820B. Gap 842 can be configured to have a dimension (i.e., a slot width and/or depth) that allows for a tilt angle adjustment of a corresponding mirror bonding plate 820B, where flexure 844 (e.g., a hinge providing a sufficient amount of spring force to adjustably attach a mirror bonding plate 820 at a desired tilt angle) is connected to a first end of gap/slot 842 and positioned toward a bottom-side or base of the rotatable polygon-shaped structure 800. Likewise, one or more other gaps/slots 842 may be configured to have respective dimensions that allow tilt angle adjustments of corresponding mirror bonding plates 820, where the respective flexures 844 are connected to a first end of a respective gap/slot 842 and positioned toward a bottom-side/base of the rotatable polygon-shaped structure 800.

In some embodiments, the polygon-shaped structure 800 further comprises a plurality of grooves 850. For example, a top-side of the polygon-shaped structure 800 comprises V-shaped groove 850 having a first half or portion 852 comprising mirror bonding plate 820B, and a second half or portion 854 comprising frame 810. One or more dowel pins, e.g., dowel pin 860, may be disposed within V-shaped groove 850 to maintain an adjustable angle of the V-shaped groove 850 at a desired tilt angle. For example, when an adjustment mechanism, e.g., tapered jack/drive screw 830, is inserted into hole 840 or screwed downward into the hole 840 (e.g., when hole 840 comprises a threaded hole) between the frame 810 and corresponding mirror bonding plate 820B, the gap 850 is operative to expand (i.e., open with an increased angle and depth) the V-shaped groove 850 such that one or more dowel pins, e.g., dowel pin 860, disposed within the V-shaped groove 850, will drop further into the groove 850. In other words, dowel pin 860 will move in a generally downward (z-axis) direction with respect to the rotational axis of polygon-shaped structure 800 such that dowel pin 860 is disposed deeper within the V-shaped groove 850. In this manner, the dowel pins 860 disposed within the V-shaped grooves 850 can provide for a hard stop of the flexure 844 at the desired tilt angle. Thus, upon reaching a desired tilt angle, the hard stop provided by the dowel pins 860 prevents the spring force of flexure 844 from causing a return or retraction to an undesired tilt angle position. In some embodiments, adhesives may be dispensed within the V-shaped groove 850 to hold the desired tilt angle(s) (and dowel pin(s) 860) in the desired position. For example, an adhesive dispensing process for holding the desired tilt angle in position may include dispensing (e.g., using hand-held dispensers/applicators, robot dispensers/applicators, or combinations thereof) controlled deposits of one or more of the following: adhesives, glues, sealants, silicones, epoxy resins, solder paste, grease, flux, solvents, lubricants, and/or other materials.

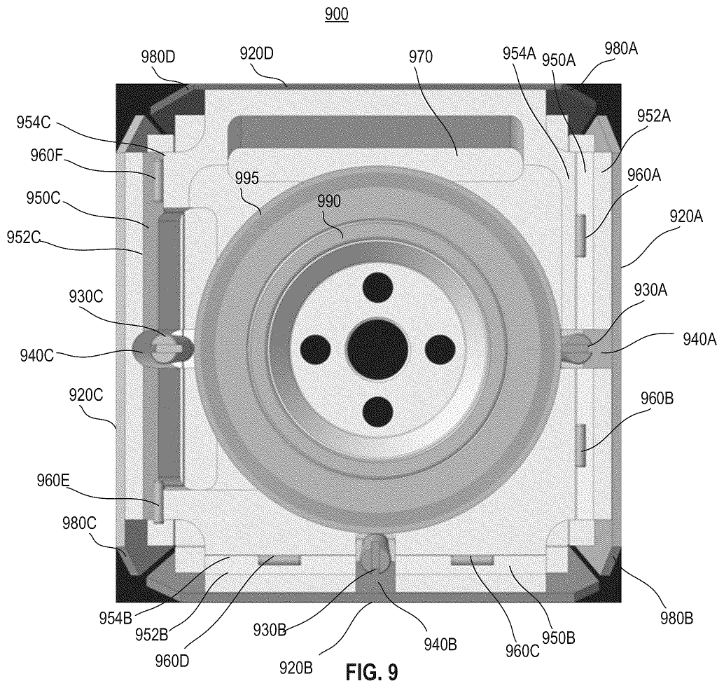

FIG. 9 is a top-side view of an example polygon-shaped structure in accordance with various embodiments. The top-side view of polygon-shaped structure 900 comprises a polygon frame 910; a plurality of wafer mirrors connected to or integrated with corresponding mirror bonding plates 920A-D; a plurality of adjustment mechanisms (e.g., tapered jack/drive screws) 930A-C disposed within respective holes 940A-C; one or more V-shaped grooves 950A-C having respective first portions 952A-C and second portions 954A-C and configured to receive one or more adjustment-stopping mechanisms (e.g., dowel pins) 960A-F; one or more cutouts 970; one or more chamfered corners 980A-D; a magnet ring 990; and an encoder ring 995.

In some embodiments, a top side of the polygon-shaped structure 900 comprises V-shaped grooves 950A-C comprising respective mirror bonding plate portions 952A-C and frame portions 954A-C. For example, V-shaped groove 950A comprises a first portion 952A rigidly connected to, or forming an integral part of, mirror bonding plate 920A and a second portion 954A rigidly connected to, or forming an integral part of, frame 910. One or more dowel pins, e.g., dowel pins 960A-F can be disposed within the V-shaped grooves 950A-C to maintain the adjustable angle of the V-shaped grooves 950A-C at a desired tilt angle. For example, when adjustment mechanisms 930A-C. e.g., tapered jack/drive screws, are inserted and/or driven into respective holes 940A-C, the adjustment mechanisms 930A-C are operative to increase respective gaps (as shown in FIG. 8) between the frame 910 and corresponding mirror bonding plates 920A-C. The adjustment mechanisms 930A-C are further operative increase the angle of the V-shaped grooves 960A-C such that dowel pins, e.g., dowel pins 960A-F, disposed within the V-shaped grooves 950A-C, will drop (i.e., move downward in a direction along the rotational axis of polygon-shaped structure 900) such that they are disposed deeper within the respective V-shaped grooves 950A-C. In this manner, the dowel pins 960A-F disposed within respective one of the V-shaped grooves 950A-C can provide for a hard stop of respective flexure springs (as shown in FIG. 8) at their desired tilt angles. Thus, upon reaching a desired tilt angle, the hard stop provided by, for example, dowel pins 960A-B prevents the flexure spring associated with mirror bonding plate 920A from returning or retracting to an undesired tilt angle position. In some embodiments, adhesives may be dispensed within the V-shaped grooves 950A-C to hold the desired tilt angle(s) (and dowel pin(s) 960A-F) in the desired position. For example, an adhesive dispensing process for holding the desired tilt angle in position may include dispensing (e.g., using hand-held dispensers/applicators, robot dispensers/applicators, or combinations thereof) controlled deposits of one or more of the following: adhesives, glues, sealants, silicones, epoxy resins, solder paste, grease, flux, solvents, lubricants, and/or other materials.

As shown, polygon structure 900 further comprises a magnet ring 990 and an encoder ring 995. Magnetic ring 990 and rotary encoder ring 995 provide for rotary operation and feedback control, respectively, of a motor (not shown) used to rotate the polygon structure 900 about a base, e.g., a base of a LIDAR device housing.

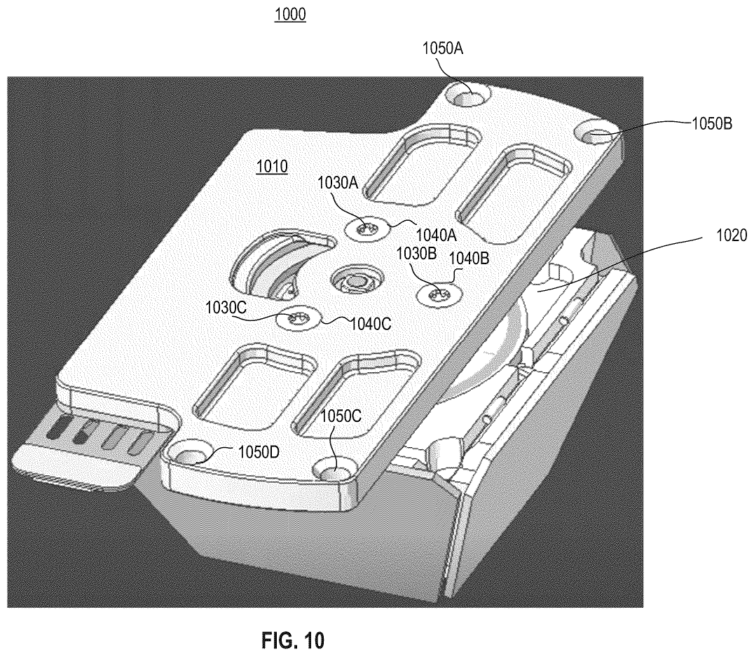

FIG. 10 is a perspective view of an example polygon-shaped structure 1000 having a top-side bracket mount in accordance with various embodiments. For example, a LiDAR device or system may comprise the polygon-shaped structure 1000 having a top-side bracket mount 1010, as shown in FIG. 10. The top-side bracket mount 1010 may be operative to connect to a frame 1020 of a polygon-shaped structure 1000 (e.g., a polygon-shaped structure as described in FIGS. 7-9 above) via screws or pins 1030A-C driven or inserted through respective attachment holes 1040A-C. Further, the top-side bracket mount 1010 can be connected to, e.g., a LiDAR device housing/enclosure (not shown) in accordance with various embodiments described above, via one or more housing mount points, e.g., mount points 1050A-D, integrated with top-side bracket mount 1010. The top-side bracket mount 1010 can be connected to a LiDAR device housing/enclosure by screws or pins (not shown) driven or inserted through respective mount points 1050A-D. As described with respect to FIG. 3 above, a LiDAR housing/enclosure can be used in a LiDAR system for providing desired characteristics such as hardness, ingress protection (IP) rating, self-cleaning capability, resistance to chemical and resistance to impact, or the like.

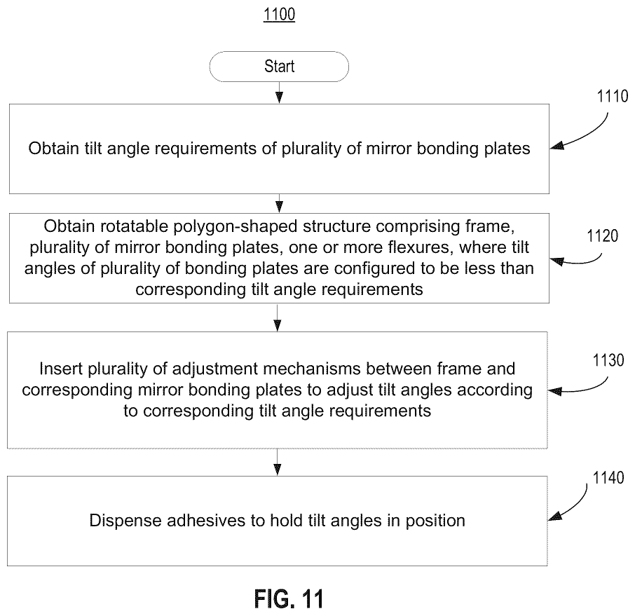

FIG. 11 is a flow diagram of a method of fabricating a light scanning device in accordance with an embodiment. In flow diagram 1100, fabricating a light scanning device comprises obtaining tilt angle requirements of a plurality of mirror bonding plates at step 1110. In some embodiments, the tilt angle requirements of the plurality of mirror bonding plates may be different for different mirror bonding plates. At step 1120, fabricating a light scanning device further comprises obtaining a rotatable polygon-shaped structure comprising a frame, a plurality of mirror bonding plates, and one or more flexures, where the tilt angles of the plurality of mirror bonding plates are configured to be less than the corresponding tilt angle requirements. At step 1130, fabricating a light scanning device further comprises inserting a plurality of adjustment mechanisms between the frame and corresponding mirror bonding plates of the plurality of mirror bonding plates to adjust the tilt angles according to the corresponding tilt angle requirements. For example, the required tilt angles may be maintained by using adjustment stopping mechanisms. In some embodiments, inserting the plurality of adjustment mechanisms unidirectionally may increase gaps between the frame and corresponding mirror bonding plates of the plurality of mirror bonding plates. At step 1140, fabricating a light scanning device may further comprise dispensing adhesives to hold the tilt angles in position. For example, dispensing adhesives may include dispensing controlled deposits of one or more of the following: adhesives, glues, sealants, silicones, epoxy resins, solder paste, grease, flux, solvents, lubricants, and/or other materials. Such adhesives may be dispensed using, e.g., hand-held dispensers/applicators, robot dispensers/applicators, or combinations thereof.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A light-scanning device comprising:
a rotatable polygon-shaped structure comprising a frame, a plurality of mirror bonding plates configured to reflect light, and one or more flexures, wherein at least some mirror bonding plates of the plurality of mirror bonding plates are adjustably attached to the frame based on corresponding flexures of the one or more flexures; and
a plurality of adjustment mechanisms inserted between the frame and corresponding mirror bonding plates of the plurality of mirror bonding plates, wherein the plurality of adjustment mechanisms is configured to adjust tilt angles of the corresponding mirror bonding plates.

2. The device of claim 1, wherein a first mirror bonding plate of the plurality of mirror bonding plates is rigidly connected to, or forms an integral part of, the frame, such that a tilt angle of the first mirror bonding plate is not adjustable.

3. The device of claim 2, wherein tilt angles of one or more other mirror bonding plates of the plurality of mirror bonding plates are adjustable.

4. The device of claim 3, wherein the plurality of mirror bonding plates comprises three mirror bonding plates in addition to the first mirror bonding plates, and wherein tilt angles of the three mirror bonding plates are adjustable with respect to the tilt angle of the first mirror bonding plate.

5. The device of claim 1, wherein at least one of the plurality of adjustment mechanisms is configured to adjust a tilt angle of the corresponding mirror bonding plate by increasing a gap between the frame and the corresponding mirror bonding plate.

6. The device of claim 5, wherein the increasing of the gap between the frame and the corresponding mirror bonding plate is unidirectional.

7. The device of claim 1, further comprising one or more slots formed between the frame and one or more corresponding mirror bonding plates of the plurality of mirror bonding plates.

8. The device of claim 7, wherein at least one flexure of the one or more flexures is connected to a first end of a first slot of the one or more slots.

9. The device of claim 8, wherein the at least one flexure is positioned toward a bottom of the rotatable polygon-shaped structure.

10. The device of claim 8, wherein the first slot is configured to have a dimension that allows tilt angle adjustment of a corresponding mirror bonding plate of the plurality of mirror bonding plates.

11. The device of claim 1, further comprising a plurality of holes disposed between the frame and corresponding mirror bonding plates of the plurality of mirror bonding plates, wherein at least one adjustment mechanism of the plurality of adjustment mechanisms is inserted at least partially into at least one corresponding hole of the plurality of holes.

12. The device of claim 11, wherein the plurality of holes comprises threaded holes and the plurality of adjustment mechanisms comprises tapered jack/drive screws.

13. The device of claim 1, wherein the polygon-shaped structure further comprises:
a plurality of grooves; and
one or more adjustment-stopping mechanisms at least partially disposed in corresponding grooves of the plurality of grooves, wherein the one or more adjustment-stopping mechanisms are configured to stop corresponding mirror bonding plates from retracting such that the tilt angles of the corresponding mirror bonding plates are maintained after adjustment.

14. The device of claim 13, wherein the one or more adjustment-stopping mechanisms comprise dowel pins.

15. The device of claim 13, wherein the plurality of grooves comprises V-shaped grooves.

16. The device of claim 1, wherein each of the plurality of mirror bonding plates comprises a reflective surface forming a side surface of the polygon-shaped structure.

17. The device of claim 16, wherein the reflective surface comprises a semiconductor wafer based reflective surface.

18. The device of claim 16, wherein the reflective surface comprises a mirror.

19. The device of claim 16, wherein the side surface of the polygon-shaped structure has a trapezoidal shape.

20. The device of claim 16, wherein the side surface has one or more chamfered corners.

21. The device of claim 1, wherein each mirror bonding plate of the plurality of mirror bonding plates has a tilt angle that is different from tilt angles of other mirror bonding plates.

22. The device of claim 1, wherein the polygon-shaped structure is configured to scan light to a field-of-view (FOV) comprising a plurality of sub-FOVs, and wherein each mirror bonding plate of the plurality of mirror bonding plates is configured to form a scan pattern by scanning light to a sub-FOV of the plurality of sub-FOVs.

23. The device of claim 22, wherein the FOV is a vertical FOV.

24. The device of claim 22, wherein degrees of insertion of the plurality of adjustment mechanisms are configured to be different such that the tilt angles of different mirror bonding plates are different.

25. The device of claim 24, wherein the tilt angles of the different mirror bonding plates are configured such that the scan patterns formed by using reflective facets of the different mirror bonding plates correspond to different sub-FOVs of the FOV.

26. The device of claim 25, wherein the scan patterns formed by using the reflective facets of the different mirror bonding plates of the plurality of mirror bonding plates are non-overlapping.

27. The device of claim 25, wherein the scan patterns formed by using the reflective facets of two adjacent mirror bonding plates of the plurality of mirror bonding plates are continuous without skipped scanlines.

28. The device of claim 25, wherein the scan patterns formed by using the reflective facets of at least two different mirror bonding plates of the plurality of mirror bonding plates are overlapping.

29. The device of claim 1, wherein at least a part of the polygon-shaped structure comprises a material that has a coefficient of thermal expansion (CTE) matching with a CTE of reflective facets of the mirror bonding plates.

30. The device of claim 29, wherein the material is titanium.

31. The device of claim 1, wherein the polygon-shaped structure further comprises one or more cutouts configured to reduce weight imbalance when rotating.

32. A light ranging and detection (LiDAR) system comprising the light-scanning device of claim 1.

33. A vehicle comprising a light ranging and detection (LiDAR) system, the LiDAR system comprising the light-scanning device of claim 1.

34. A method of fabricating a light-scanning device, the method comprising:
obtaining tilt angle requirements of a plurality of mirror bonding plates;
obtaining a rotatable polygon-shaped structure comprising a frame, a plurality of mirror bonding plates, and one or more flexures, wherein tilt angles of the plurality of mirror bonding plates are configured to be less than the corresponding tilt angle requirements; and
inserting a plurality of adjustment mechanisms between the frame and corresponding mirror bonding plates of the plurality of mirror bonding plates to adjust the tilt angles according to the corresponding tilt angle requirements.

35. The method of claim 34, further comprising:
maintaining the required tilt angles using adjustment stopping mechanisms; and
dispensing adhesives to hold the tilt angles in position.

36. The method of claim 34, wherein the tilt angle requirements of the plurality of mirror bonding plates are different for different mirror bonding plates.

37. The method of claim 34, wherein inserting the plurality of adjustment mechanisms unidirectionally increases gaps between the frame and corresponding mirror bonding plates of the plurality of mirror bonding plates.
